(19) United States
(12) Patent Application Publication
(10) Pub. No.: US 2010/0287965 A1
(43) Pub. Date: Nov. 18, 2010

(54) Cooling Garment

(76) Inventor: Steven Michael Bryant, Laguna Beach, CA (US)

Correspondence Address: ERIC HANSCOM, 2141 Palomar Airport Road, Suite 320, CARLSBAD, CA, 92011, US

(21) Appl. No.: 12/779,942

(22) Filed: May 13, 2010

Related U.S. Application Data
(60) Provisional application No. 61/178,051, filed on May 14, 2009.

(51) Int. Cl. F25B 15/00; F25D 31/00; B32B 27/34; B32B 3/30

(52) U.S. Cl. 62/259.3; 62/259.4; 428/474.4; 428/172

(57) ABSTRACT

A new method of sandwiching evaporative cooling materials such as Polyacrylamide crystals in between two or more outer layers of thin membrane is disclosed. The Polyacrylamide crystals are retained through the heat welding—as opposed to the traditional stitching—of the outer membranes to each other. This allows for the resulting material to be cut into a variety of patterns that can later be sewn or heat welded together to form a variety of cooling products. It also allows for heat-stamping where the heat-stamping machine has patterns that are welded onto the membranes, trapping the evaporative cooling components in one or more patterns, which can be located over specific body regions for effective cooling and/or cushioning and protection of that body region. Patterns can be designed such that negative spaces are created, whereby airflow can be channeled to accelerate the evaporative cooling process over certain body regions.

### CROSS REFERENCE TO RELATED APPLICATIONS

This application claims priority from U.S. Provisional Application No. 61178051 entitled “Layer of evaporative cooling material utilizing Polyacrylamide crystals in a sandwich of one or more outside layers of material, method of manufacturing material capable of being used in variety of cooling applications involving layering technique with Polyacrylamide crystals, and method of cooling a human, animal, object, or environmental space utilizing a layer of evaporative cooling material utilizing Polyacrylamide crystals in a sandwich of one or more layers of outside material”, filed May 14, 2009, the contents of which are incorporated herein by reference.

### STATEMENT REGARDING FEDERALLY SPONSORED RESEARCH OR DEVELOPMENT

This invention was not federally sponsored.

### BACKGROUND OF THE INVENTION

### Field of the Invention

This invention relates to the general field of methods of making evaporative material that can be later made into clothing and other items that a person can wear as well as being used to cool engines and other non-living items which require cooling. More specifically, the invention is a method of heat fusing Polyacrylamide crystals in the middle of one of more layers of surrounding material such that material can later be die cut into any shape desired without appreciable loss of the Polyacrylamide crystals from any cut edge. The Polyacrylamide crystals are retained through the heat welding—as opposed to the traditional stitching—of the outer membranes to each other. This allows for the resulting material to be cut into a variety of patterns that can later be sewn or heat welded together to form a variety of cooling products. The invention also provides the ability to heat press a customized, “stamped-out” pattern of crystal or gel designs that can promote the name or logo of a business. The invention also allows for the selection positioning of cooling pockets of crystals or gel on specific parts of the wearer's body, such that cooling is applied specifically to those body areas needing cooling. The depth and size of the patterns can be varied to allow for selective and adjustable cushioning of specific regions of the body, such that a user of the invention can be protected from injury as well as effectively cooled. Finally, through channeling air through the negative spaces in the panel, and through specific designs in the negative spaces, the cooling effect can be accelerated, thereby allowing for the creation of cooling garments that specifically focus the cooling effects on specific body regions.

The goal of the current invention is to make a sandwiched material that can be used for cooling a wide variety of objects, including humans, animals, machines, and the general environment. This application covers a layer of evaporative cooling material utilizing Polyacrylamide crystals in a sandwich of one or more outside layers of material, a method of manufacturing material capable of being used in variety of cooling applications involving layering technique with Polyacrylamide crystals, and a method of cooling a human, animal, object, or environmental space utilizing a layer of evaporative cooling material utilizing Polyacrylamide crystals in a sandwich of one or more layers of outside material, where the Polyacrylamide crystals are encapsulated inside of quilted sections, or screened out into a retaining matrix.

### History of the Relevant Industry

Evaporative cooling is a well known means by which an object can be cooled. It works due to the fact that when water evaporates from an object, it requires energy to do so; that energy correlates to a net result of heat loss which provides the cooling desired by the user. The most effective cooling materials are those which can absorb heat from an object readily and release that heat through evaporation of water that has been placed on the material.

As the object transfers heat to the cooling material, the water in/on the cooling material begins to evaporate. This is because the side of the material next to the object has a high relative humidity relative to the side of the material exposed to air. As a result, water molecules move from the inside to the outside surface and evaporate into the atmosphere, using some heat to accomplish the evaporation, and thereby cooling the object.

The prior art has a wide range of past attempts to use evaporative cooling to keep an object cool. Although several garment options are available for cooling humans and animals, these options have limitations. For example, humans often wet towels or other cloths to wrap around various body parts to combat heat. While this method may achieve the desired effect, towels do not provide for flexibility in movement and are susceptible to drying at a rapid rate. Also, towels do not provide a convenient garment that can be secured to a body that allows for flexible movement without the towel falling off, as opposed to the current invention that produces a material that can be cut into any desired configuration, and incorporated into clothing. Another attempt to keep humans cool has been the creation of lightweight and breathable clothing. However, this clothing only helps to prevent heat buildup rather than actually cooling the wearer.

Various garments also exist for animals, such as the horse blankets taught by German Patent Application Nos. DE 20 2005 012 350 U1 2005.11.24 and DE 20 2005 012 352 U1 2005.11.24 to Busse Sportartikel. These inventions, however, do not provide for cooling of the horse during times of hot weather or after periods of exercise, as they do not rely upon the principles of evaporative cooling to the extent that the current invention does, and they do not incorporate the Polyacrylamide crystals as does the current invention.

The concept of evaporative cooling garments that go beyond a simple piece of material is not unique. One category of such garments is the complex garments utilizing channels or chambers to direct the cooling efforts. For example, US Patent Application No. 2003/0208831 to Lazar, et. al., discloses a very complex cooling garment that rather than relying upon a material such as the current invention that has a solid core, instead provides a complex and expensive evaporative cooling garment manufactured from a multi-layered fabric with chambers where holes created by sewing or stitching channel the water into the chambers. Other evaporative cooling inventions are taught by U.S. Pat. Nos. 6,295,648, 6,276,155 and 6,257,011 to Siman-Tov, et. al. These patents provide a shirt with channels which absorb sweat and/or evaporative liquid and a device to then move air through the channels to create the cooling effect. While these inventions may provide evaporative cooling to a human or animal user of the invention, they lack the simplicity (and, inherent to the simplicity, the low cost and ease of use) of the current invention. These inventions do not also offer the selective positioning of cooling pockets that the current invention offers, nor do they provide the ability to easily create an “advertising panel” as is made possible by the current invention.

Another evaporative cooling garment is found in US Patent Application No. 2005/0246826 to McCarter, et. al. “ridge and channel ribs”, against which the same criticisms could be leveled as with the Siman-Tov patents. Another complex evaporative cooling device is illustrated in U.S. Pat. No. 5,438,707 to Horn, which discusses a series of hollow tubes networking within a vest which convey pressurized air and create evaporative cooling. A similar idea is taught by US Patent Application No. 2004/128747 to Bumbarger, et. al., in which a reservoir of water can be used to drink or dissipate the water for evaporative cooling purposes. Another patent illustrating the complexity of inventions which require a coolant supply is U.S. Pat. No. 5,715,533 to Stein. This patent teaches a baseball cap with an interconnected series of veins through which coolant from a reservoir attached to the side of the baseball cap can flow to cause evaporative cooling.

While these garments do provide evaporative cooling to the wearers of the garments, the complexity of these inventions causes them to be considerably more expensive and difficult to use than the current invention. For example, any evaporative cooling device requiring a reservoir or power supply to activate a fan requires a user of those inventions to keep the fluids up and batteries charged. Additionally, any garment requiring tubes, channels or other means of directing air or water requires a substantially greater amount of design costs, will take more expensive materials, and will eventually cost more than the invention proposed herein.

Another evaporative cooling garment is described in U.S. Pat. No. 6,473,910 to Creagan, et. al. This invention calls for three layers of fabric, each with specific characteristics, where the layers are bonded together by heating various regions sufficiently for the layer to melt and resolidify to form inter-fiber bonds. A similar invention is found in US Patent Application No. 2002/0069448 to Appolonia, which provides an evaporative material comprised of three layers of fabric. These inventions, however, calls for multiple layers, or for at least one of the layers to have more than a single component, which is more complex that the current invention and, therefore is not as simple to manufacture and it would be more difficult and expensive to manufacture.

Another category of evaporative cooling garments are basically cooling undershirts, designed to be worn under body armor or other similarly bulky and non-breathable devices. For example, there are a number of patents dealing with undergarments which allow for passive air circulation—and thereby allows for evaporative cooling—based upon a three-dimensional honeycomb structure which is strong enough to maintain the open air passages even when compressed under body armor. U.S. Pat. No. 4,170,793 to O'Brien also teaches an evaporative cooling undergarment for use under body armor which is equally complex and reliant upon strong, resilient materials. While the structural rigidity of these inventions may be necessary to maintaining air passages under the weigh of body armor, such advanced designs (and highly priced products) are not necessary for the human/animal and inanimate object evaporative cooling market the current invention services. Thus, one of the main drawbacks in the prior art is that no inventor so far has combined an effective means of selectively cooling to body of the wearer with effective and lightweight protective gear.

Therefore, there is a current need for a convenient to use, cost-effective and flexible cooling material that be easily manufactured, provide cushioning to the user in case of accidents, and be commercially desirable from a sponsorship perspective. The current invention provides just such a product by providing a product that combines cushioning and cooling properties in a lightweight material, allows for the selective positioning of cooling regions on specific body regions especially useful for cooling, creates negative spaces and uses these negative spaces to channel air such that the evaporative cooling effect is enhanced, and allows for the effective creation of garments with names, logo and other advertising indicia attractively and synergistically located such that the garments can be customized for a particular brand or sponsor.

Allowing for the selective position of cooling pockets is important. Scientific studies have shown that certain parts of the body are more effective as dissipating heat than are others. For example, because of the comprehensive network of veins and arteries, the scalp may allow a person to “vent” around 30% of his/her total heat through this region. Thus, having a small cooling pocket on the top of the skull may be a more effective means of cooling a person than a much larger cooling pocket across the back.

The cushioning aspect of this invention is also important. Many of the action sports most popular today require the user to wear protective gear under warm or hot conditions. For example, motorcycle riders, whether recreational bikers riding along a road or competitive motocross riders having a race or trick competition, have to wear protective clothing in case they fall off their motorcycles or crash into another motorcycle. This clothing is especially hot during the summer months. Thus, it is highly desirable to have a protective garment that will cushion a fall as well as cool the body the rest of the time. Bike riders are in a similar situation. Many desire long sleeved shirts, even in the heat of summer, for protection against sunburn and road-rash during a fall, and yet such a long-sleeved shirt may prove quite hot. With the current invention, a pocket of evaporative cooling material can be heat-stamped on a specific part of a garment, thereby providing the user some protection against injury as well as cooling benefits.

To accelerate the evaporation of water, a number of compounds have been tried in evaporative cooling products. Polyacrylamide crystals are one of those compounds. The use of Polyacrylamide crystals in cooling garments is not novel. There have been many past uses of Polyacrylamide crystals to provide the hydrophobic pressures needed to rapidly expel water from the surface of a material, thereby accelerating evaporation. None of the past uses, however, have provided a method by which the Polyacrylamide crystals can be successfully contained in a sandwiched layer which, no matter how it is cut, will retain the Polyacrylamide crystals and not lose them out the cuts as has been the problem with past inventions. None of the past uses also allow for the creation of customized, heat-stamped patterns that allow for advertising logo and/or the selective positioning of cooling “pockets” near body regions especially susceptible to overheating.

Instead, the current invention allows for welding the fabric around die cut polyacrylamide sheeting as well as die cutting both the fusible webbing and the polyacrylamide sheeting. Additionally, the invention teaches the ability to “screen print” fabric with polyacrylamide “slurry” in various patterns and meld the layers together around the slurry. All of these methods provide for a faster production time and no gel leakage which are the issues facing the current state of the art with manufacturers using polyacrylamide for evaporative cooling garments. By heat-stamping a pattern into a material, there are no sewing “holes” through which any of the evaporative cooling material can leak out. By adjusting the size of the “pockets” of cooling material, the manufacturer can also minimize the danger that the cooling material will wad up at one end of the pocket and lose its effectiveness.

The use of quilting to retain an inner substance within outer confines is well known. Not surprisingly, there are examples of garments which have used quilted material in which one of the inner substances was Polyacrylamide. There is a major problem with the use of sewing with needle and thread as the method of making the quilted pattern. First, Polyacrylamide crystals will leak out of the holes made by the needle. Second, because the boundaries between different quilted sections is a semi-permeable meeting between the two outer layers, Polyacrylamide crystals can seep from one section to another, through the narrow but open sections between the stitches. None of the past uses have also provided a method by which the Polyacrylamide crystals can be successfully quilted into a layer of material where the quilting is done without stitching of any kind.

Thus, it was known in the prior art that Polyacrylamide crystals accelerated the evaporation of water from a material, but it was not know how to effectively contain the Polyacrylamide crystals within the sandwich of material once the material was cut into a desired shape. The prior art also provides several products that have Polyacrylamide crystals adhered to them, but fails to provide a method by which the Polyacrylamide crystals can be quilted in between two or more layers of material without the Polyacrylamide crystals leaking out the needle holes or from one section to another.

Thus there has existed a long-felt need for a method of making a sheet of material in which the Polyacrylamide crystals are retained, such that the sheet of material can be die cut into patterns without losing any of the Polyacrylamide crystals out of the cut portions.

The current invention provides just such a solution by having a new method of sandwiching Polyacrylamide crystals in between two or more outer layers of thin membrane is disclosed. The Polyacrylamide crystals are retained through the heat welding—as opposed to the traditional stitching—of the outer membranes to each other. This allows for the resulting material to be cut into a variety of patterns that can later be sewn or heat welded together to form a variety of cooling products. The heat welding forms a solid seal between the different sections of the quilt such that there is no migration of Polyacrylamide crystals from one section to another, and because held welding rather than needle and thread is used, there is no loss of Polyacrylamide crystals through needle holes. The resulting fabric sheet can be cut into a variety of shapes for a multitude of potential uses, without having its evaporative and cooling qualities diminished over time by loss of Polyacrylamide crystals.

An alternative method is to heat-stamp out a pattern, with the cooling crystals located in one or more “pockets”, where the pockets can form a pattern—either a decorative pattern or an advertising logo—or spell out the name of a company. The patterns can be designed to create “negative spaces”, which can actually increase the velocity of air passing through, thereby increasing the evaporative cooling rate which, in turn, increases the effectiveness of the cooling process.

One of the unexpected benefits of using heat welding or heat stamping to create the quilting pattern is that the quilting pattern can be created with a die cut in mind, such that the edges of a particular piece can be heat welded and cut at the same time. This saves manufacturing steps, and saves time as well. It also prevents the loss of Polyacrylamide crystals and the outer layers of material if a cut was made through a quilted section—indeed, the method allows for the cut to determine the edge of a particular quilted section.

Another iteration of the invention calls for the heat welded sections between the quilted portions containing the Polyacrylamide crystals to be decoratively shaped, such that the raised, quilted sections stand out from the rest of the panel. This method is particularly useful in applications where it is not necessary to have the entire panel provide cooling, and allows for both the creation of decorative patterns or advertising material to be presented on the eventual garment, and for the selective position of “pockets” for cooling and/or protection.

The invention also contemplates additional, alternative means of creating a leak-proof quilting pattern in addition to heat fusing. Among the contemplated alternative means are gluing, die cut fusible webbing, or even screened on in a process similar to silk screening to create a bonded surface around each quilted section.

### SUMMARY OF THE INVENTION

It is a principal object of the invention to provide a method by which Polyacrylamide crystals can be manufactured into a sandwich-type sheet of material, where the Polyacrylamide crystals are retained to the extent that a person can die cut the sheet of material and an appreciable amount of the Polyacrylamide crystals do not spill out the cut sides.

It is another object of the invention that this sheet of material can be used to make a variety of cooling objects.

It is an additional object of the invention that the material can be used as part of a cooling item, or cut into patterns such that the entire cooling item is made from the material.

Further objects of the invention include a method by which a quilted section can be created by heat welding, such that Polyacrylamide crystals cannot leak out of the quilted section either through needle holes, as found in traditionally quilted sheets of material, or from one quilted section to an adjoining section.

A further object of the invention is to provide a method by which a desired shape containing Polyacrylamide crystals can be created using heat welding to not only create a pattern but also to cut the edges according to a predetermined pattern.

Another object of the invention is to provide a method by which a desired shape can first be heat welded, and then cut by die cut means.

It is a further object of the invention that the invention be usable for human/animal uses as well as for the cooling of inanimate objects and to provide cooling to specific environments.

It is also an object of this invention that the user of the process can add elements to the Polyacrylamide crystals to enhance the eventual user's pleasure in wearing the device, such as essential oils and other items related to aromatherapy.

Another object of the invention is to provide a cooling garment that has been heat-stamped with cooling products such as polyacrylamide crystals in pockets, where the pockets are decorative in nature.

A further object of the invention is to provide pockets which are designed to display advertising indicia.

Another object of the invention is to provide a cooling garment that has cooling pockets created in specific parts of the garment such that specific body regions are cooled.

Other objects of the invention include the creation of negative spaces, including negative spaces that channel air flow such that evaporative cooling is enhances in certain regions of the garment.

A further object of the invention is to provide cooling pockets that also serve a cushioning function, such that if a wearer of the invention falls, hits something, or otherwise has an accident, the cooling/protective pocket will cushion the impact.

It is a final object of this invention that the method of manufacture produce a superior product at a price lower than that found in much of the prior art. That the invention allows for the manufacture of fabric containing the polyacrylamide in mass to be cut and sewn into any shape needed for any application

It should be understood the while the preferred embodiments of the invention are described in some detail herein, the present disclosure is made by way of example only and that variations and changes thereto are possible without departing from the subject matter coming within the scope of the following claims, and a reasonable equivalency thereof, which claims I regard as my invention.

There has thus been outlined, rather broadly, the more important features of the invention in order that the detailed description thereof may be better understood, and in order that the present contribution to the art may be better appreciated. There are additional features of the invention that will be described hereinafter and which will form the subject matter of the claims appended hereto. The features listed herein and other features, aspects and advantages of the present invention will become better understood with reference to the following description and appended claims. The accompanying drawings, which are incorporated in and constitute part of this specification, illustrate embodiments of the invention and, together with the description, serve to explain the principles of the invention.

### BRIEF DESCRIPTION OF THE FIGURES

FIG. 1 is a cross-sectional view of a typical sheet of material showing the process behind its manufacture.

FIG. 2 provides cross-sectional and exploded views of one embodiment of the invention, showing the quilted cooling bladder in between two sheets of fusible webbing with two outer shell layers.

FIG. 3 provides cross-sectional and exploded views of one embodiment of the invention, showing another embodiment with patches on the exterior of the outer layer that can absorb essential oils and aromatherapy products.

FIG. 4 is a cross-sectional view of a heat stamping machine with a removable pattern.

FIG. 5 is a perspective view and a cross sectional view of a pattern of evaporative cooling material on a finished section of material.

### DETAILED DESCRIPTION OF THE FIGURES

Many aspects of the invention can be better understood with references made to the drawings below. The components in the drawings are not necessarily drawn to scale. Instead, emphasis is placed upon clearly illustrating the components of the present invention. Moreover, like reference numerals designate corresponding parts through the several views in the drawings.

Before explaining at least one embodiment of the invention, it is to be understood that the embodiments of the invention are not limited in their application to the details of construction and to the arrangement of the components set forth in the following description or illustrated in the drawings. The embodiments of the invention are capable of being practiced and carried out in various ways. In addition, the phraseology and terminology employed herein are for the purpose of description and should not be regarded as limiting.

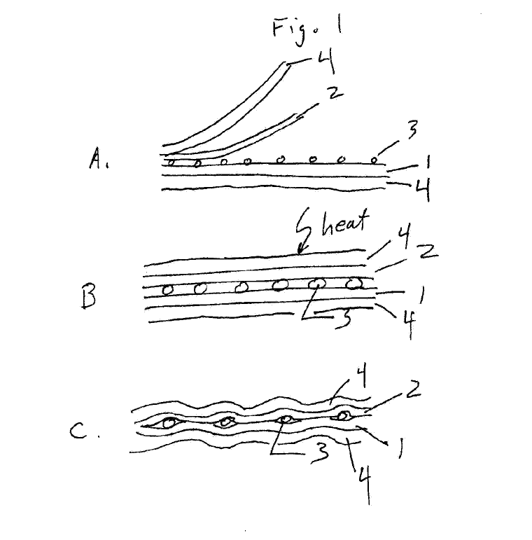

FIG. 1 is a cross-sectional view of a typical sheet of material showing the process behind its manufacture. The invention in this iteration comprises a bottom layer of thin membrane (1), a top layer of thin membrane (2), and a plurality of Polyacrylamide crystals (3). In Phase A, the bottom layer has been laid out on a manufacturing table and sprinkled with a plurality of Polyacrylamide crystals. The top layer is being laid over the Polyacrylamide crystals. In Phase B, the top layer has been laid over the Polyacrylamide crystals and heat is being applied. In Phase C, the heat welding is complete and the top and bottom membranes have melted together to encapsulate each Polyacrylamide crystal. Thus, later on when the sheet of material is cut, the Polyacrylamide crystals will be retained within the sheet of material and will not spill out the sides. A preferred embodiment calls for two outer layers (4)

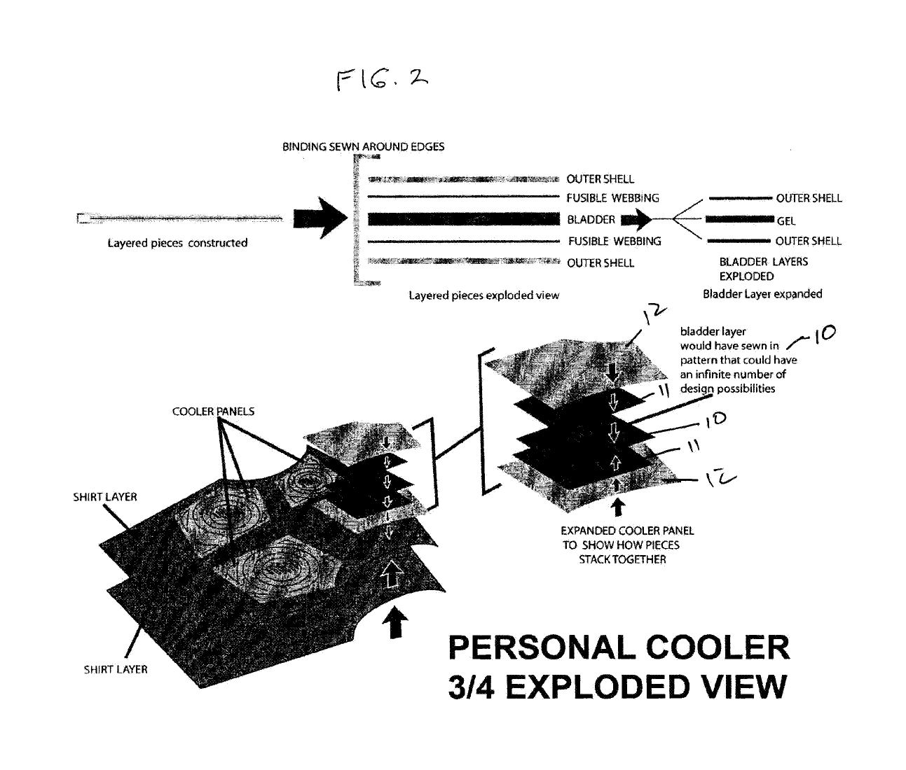

FIG. 2 provides cross-sectional and exploded views of one embodiment of the invention, showing the quilted cooling bladder (10) in between two sheets of fusible webbing (11) with two outer shell layers (12). An inner bladder is comprised of a gel layer containing Polyacrylamide crystals in a matrix sandwiched in between two outer shell layers. The matrix can be made from a variety of materials, including but not limited to Cotton, Poly blends, silk, and other suitable materials. The outer shell layers can also be made from a variety of materials, including but limited to paper, canvas, film and other suitable materials. The bladder layer can be sewn, but the preferred embodiment calls for heat welding or some other means by which the individual quilted sections can be effectively sealed, such that the Polyacrylamide crystals do not leak out any needle holes or migrate from one quilted section to another.

The bladder layer can be quilted into any number of shapes with an equally large number of quilting patterns. For example, with a piece of material that is eventually destined to be part of a cooling garment, individual sleeve and torso sections could be delineated through the heat welding process and then die cut, or even cut as part of the heat welding process itself.

It is intended that this process could be used not only to create a garment where the entire garment is created from Polyacrylamide-containing quilted sections, but also to create smaller cooling sections that could be placed within a larger section of material to create a garment or other cooling device where only a portion of the garment has evaporative cooling capabilities.

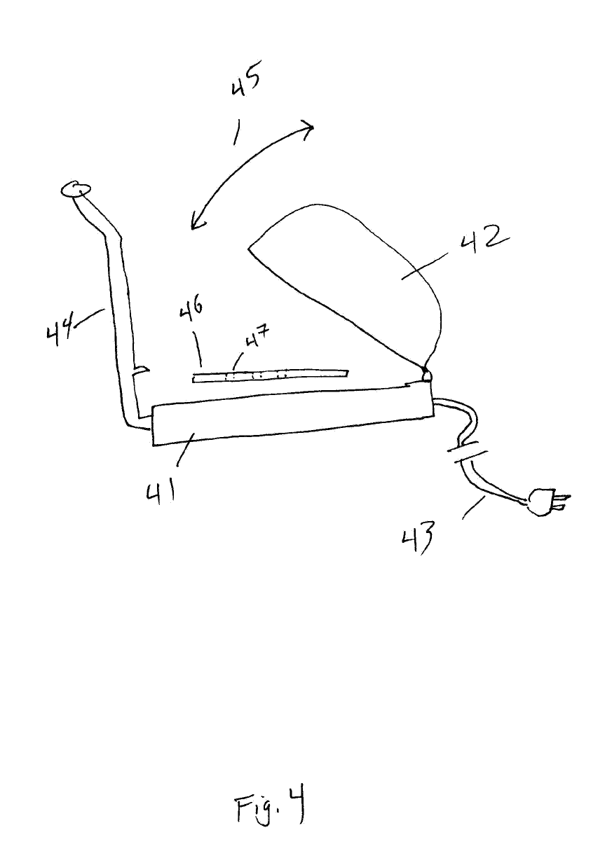

FIG. 4 is a cross-sectional view of a heat stamping machine with a removable pattern. The heat stamping machine, which is not claimed as part of this invention, has a lower surface (41), and upper surface (42), where the upper surface rotates in a direction indicated by (45), a source of heat (43) here shown as an electrical cord, and a latch (44) by which the upper surface can be clamped down on the lower surface while heat is applied. There is a pattern (46) which has holes, cuts or surface irregularities (47) that are used to make a resulting pattern in the material produced.

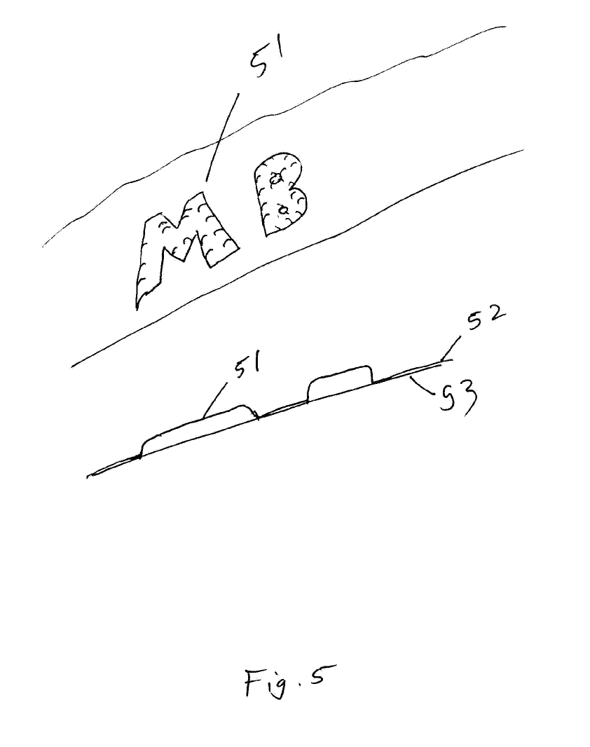

FIG. 5 is a perspective view and a cross sectional view of a pattern of evaporative cooling material on a finished section of material. In this example, a pattern with holes or slits of the initials “MB” were cut into the pattern (46 in FIG. 4), resulting in the evaporative cooling material being condensed into two pockets (51) which rise above the sections where the upper layer (52) and lower layer (53) have been heat welded together. This illustration shows how an advertising logo could be created. If the piece of material being created in a specific shape to be later constructed into a garment, the pattern could be designed and located on a specific section of the material to provide a variable amount of cooling ability, and a variable amount of cushioning and protective ability, to a specific region of the garment.

A further embodiment on this idea is to have the bladder portion actually embossed on the outside of the garment or other cooling item, thereby providing the opportunity to use the bladder portion as a decorative element of the garment.

Another embodiment of the invention calls for the heat welded sections between the quilted sections to have varying sizes and shapes, such that an eye-pleasing pattern is created.

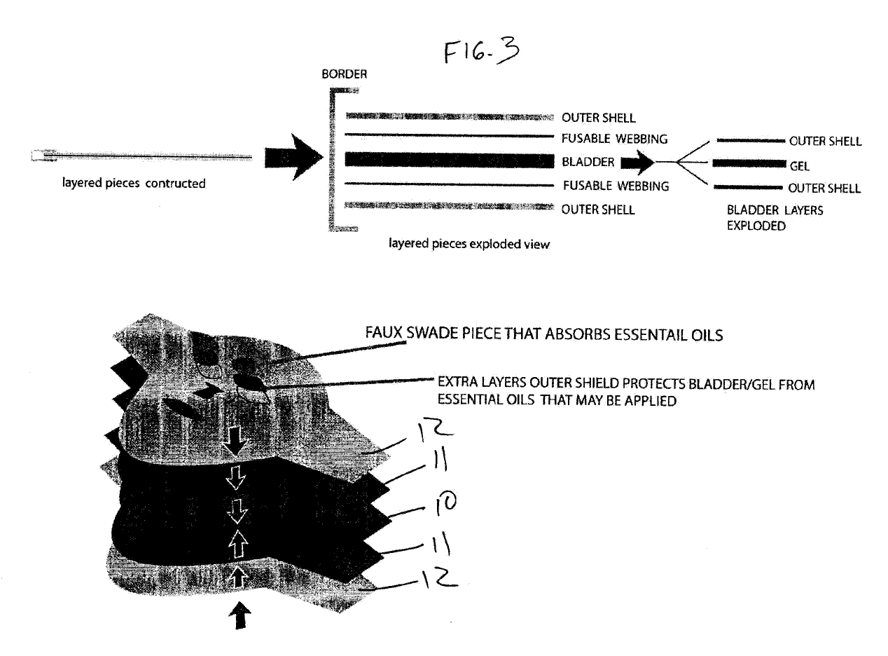

FIG. 3 provides cross-sectional and exploded views of one embodiment of the invention, showing another embodiment with patches on the exterior of the outer layer that can absorb essential oils and aromatherapy products. There are several means by which pleasant smelling and therapeutic oils can be used with the Polyacrylamide crystal-containing cooling material. In a preferred embodiment, a substantially waterproof section can be laid down on the outer layer, followed by an absorbent layer, into which the additives can be allowed to seep in and be absorbed. There are a number of different uses for the material resulting from this process. One such use is to cut the material according to a pattern, and to make cooling garments from the material. One embodiment of the invention is to have the entire cooling garment manufactured from the material; another embodiment calls for certain panels to be made from the material, but for the rest of the garment to be made from non-Polyacrylamide containing material.

Garments may be used by humans or animals. For humans, the material can be used to make any type of garment traditionally worn, ranging from hats, bandanas and mufflers to pants, shirts, and sarongs. It is anticipated that animal garments will be particularly useful for horse races, dog shows, zoos where animals from cold climates are kept in temperatures higher than those they are used to, and circuses.

Medical treatment uses are also contemplated. For example, the material could easily be made into a face mask for the treatment of headaches. It is also expected that the treatment of burns could be improved through use of the material on dressings.

It is also contemplated that the invention could be useful for mattress pads for women with Menopause, medical cooling wraps, horse blankets deck chair covers, riding chaps, helmet liners seat cushions

The material could work equally well in cooling inanimate objects. For example, have a cooling “jacket” on an automobile engine where a source of water was constantly dripped onto the jacket could keep the temperature of an automobile engine lower than normal. A cooling jacket placed over an airplane engine could be saturated with water upon takeoff, and then allowed to dry out as cruising altitude was reached. As the plane descended, water could again be dripped onto the material, thereby lowering the temperature of the engine.

Environmental control uses are also contemplated. For example, a panel of the material could be hung in a room, or even used as a window. With a regular source of water dripping down the panel, a constant cooling effect would be achieved. If the membrane material was transparent or translucent, the panels could be used as windows or even as the interior portion of a door.

Other embodiments of the method involve adding various items to the Polyacrylamide crystals. One such use could be the addition of essential oils and other aromatherapy items onto the bottom layer before the top layer is heat welded to it. Another possible embodiment could be the addition of magnetic matter or crystal matter into the sandwich.

It should be understood that while the preferred embodiments of the invention are described in some detail herein, the present disclosure is made by way of example only and that variations and changes thereto are possible without departing from the subject matter coming within the scope of the following claims, and a reasonable equivalency thereof, which claims I regard as my invention.

All of the material in this patent document is subject to copyright protection under the copyright laws of the United States and other countries. The copyright owner has no objection to the facsimile reproduction by anyone of the patent document or the patent disclosure, as it appears in official governmental records but, otherwise, all other copyright rights whatsoever are reserved.

What I claim is:

1. A sheet of material with a top side and a bottom side, capable of being used for evaporative cooling, comprising a plurality of outer layers, a plurality of fusible webbing layers, and a bladder, where the bladder is comprised of a plurality of outer shells and a gel matrix, where the gel matrix contains, among other substances, Polyacrylamide.

2. The sheet of claim 1, where the Polyacrylamide is in the form of Polyacrylamide crystals, and where there are at least two outer layers on the top side and the bottom side, and inside of the at least two outer layers are at least two fusible webbing layers, and inside of the at least two fusible webbing layers there is the gel matrix.

3. The sheet of claim 2, where the number of outer layers is two and the number of fusible webbing layers is two, and where the fusible webbing layer additionally comprises a plurality of quilted sections, where each quilted section comprises a heat welded boundary and a fill portion, where each quilted section is created through heat welding the fusible webbing layers to each other.

4. The sheet of claim 3, where the heat welding process is used to create one or more patterns, where each pattern comprises one or more heat welded sections and one or more quilted sections.

5. The sheet of claim 4, where the locations of the heat welded boundaries are predetermined based on an intended eventual use for a particular piece of the sheet.

6. The sheet of claim 2, additionally comprising one or more absorbent portions of material, located on the top or bottom, with the ability to absorb a substance, where the substance is selected from the group consisting of essential oils and aromatherapy scents, and additionally comprising a substantially waterproof layer under the absorbent portions and outside of the top layer and the bottom layer.

7. A sheet of material consisting of: a top sheet of material, a bottom sheet of material, an evaporative cooling compound, where the evaporative cooling compound contains, at least, Polyacrylamide, where the evaporative cooling compound is in the form of a gel, and where the top sheet of material can be attached to the bottom sheet of material through application of heat, where the application of heat is accomplished through the heat-stamping process, and where the heat-stamping process comprises a top heating element and a bottom heating element which are hingably attached to each other, a source of heat, such as electricity, additionally comprising at least one pattern, where the at least one pattern is can be removably attached to at least one of the top heating element and the bottom heating element, and where one or more and at least one pocket of evaporative cooling material is created by the heat-stamping process, and the at least one pocket is in the shape of the at least one pattern.

8. The sheet of material of claim 7, where the sheet of material is of a shape that will facilitate its combination with one of more other pieces of material, where the combination of more than one piece of material will create a garment, where at least one pocket is located on the garment in a location that will place the at least one pocket over a body part of the user of the invention that dissipates heat rapidly, thereby enhancing the dissipation of heat from the user of the invention.

9. The sheet of material of claim 7, where the sheet of material is of a shape that will facilitate its combination with one of more other pieces of material, where the combination of more than one piece of material will create a garment, where at least one pocket is located on the garment in a location that will place the at least one pocket over a body part of the user of the invention for which additional protection is desired, such as the head or elbow of the user, thereby enhancing the protection of the user of the invention.

10. The sheet of material of claim 7, where the sheet of material is of a shape that will facilitate its combination with one of more other pieces of material, where the combination of more than one piece of material will create a garment, where at least one pocket is located on the garment in a location that will place the at least one pocket over a body part of the user of the invention for which additional protection is desired, such as the head or elbow of the user, thereby enhancing the protection of the user of the invention, and where at least one pocket is located on the garment in a location that will place the at least one pocket over a body part of the user of the invention that dissipates heat rapidly, thereby enhancing the dissipation of heat from the user of the invention.

11. The sheet of material of claim 7, where at least one pocket additionally comprises at least one negative space, where the negative space is of a design that channels airflow in a direction that increases evaporative cooling over at least one desired location on the sheet of material.

12. A garment comprising at least one piece of material, where the material comprises: a top sheet of material, a bottom sheet of material, an evaporative cooling compound, where the evaporative cooling compound contains, at least, Polyacrylamide, where the evaporative cooling compound is in the form of a gel, and where the top sheet of material can be attached to the bottom sheet of material through application of heat, where the application of heat is accomplished through the heat-stamping process, and where the heat-stamping process comprises a top heating element and a bottom heating element which are hingably attached to each other, a source of heat, such as electricity, additionally comprising at least one pattern, where the at least one pattern is can be removably attached to at least one of the top heating element and the bottom heating element, and where one or more and at least one pocket of evaporative cooling material is created by the heat-stamping process, and the at least one pocket is in the shape of the at least one pattern.

13. The garment of claim 12, where at least one pocket is located on a section of the garment that covers a region of the wearer's body that is especially prone to injury from a fall or accident, such as the head, elbow or knee.

14. The garment of claim 12, where at least one pocket is located on a portion of the garment that lies over a part of the user's body that is a particularly effective location for evaporative cooling of the body.

15. The garment of claim 12, where at least one pocket additionally comprises at least one negative space, where the negative space is of a design that channels airflow in a direction that increases evaporative cooling over at least one desired location on the sheet of material.

16. The garment of claim 12, where the garment consists of one of more pieces of material; where each piece of material consists of: a top sheet of material, a bottom sheet of material, an evaporative cooling compound, where the evaporative cooling compound contains, at least, Polyacrylamide, where the evaporative cooling compound is in the form of a gel, and where the top sheet of material can be attached to the bottom sheet of material through application of heat, where the application of heat is accomplished through the heat-stamping process, and where the heat-stamping process comprises a top heating element and a bottom heating element which are hingably attached to each other, a source of heat, such as electricity, additionally comprising at least one pattern, where the at least one pattern is can be removably attached to at least one of the top heating element and the bottom heating element, and where one or more and at least one pocket of evaporative cooling material is created by the heat-stamping process, and the at least one pocket is in the shape of the at least one pattern.

17. The garment of claim 16, where at least one pocket is located on the garment in a location that will place the at least one pocket over a body part of the user of the invention that dissipates heat rapidly, thereby enhancing the dissipation of heat from the user of the invention.

18. The garment of claim 16, where at least one pocket is located on the garment in a location that will place the at least one pocket over a body part of the user of the invention for which additional protection is desired, such as the head or elbow of the user, thereby enhancing the protection of the user of the invention.

19. The garment of claim 16, where at least one pocket is located over a body part of the user of the invention for which additional protection is desired, such as the head or elbow of the user, thereby enhancing the protection of the user of the invention, and where at least one pocket is located in a location that will place the at least one pocket over a body part of the user of the invention that dissipates heat rapidly, thereby enhancing the dissipation of heat from the user of the invention.

20. The garment of claim 16, where at least one pocket additionally comprises at least one negative space, where the negative space is of a design that channels airflow in a direction that increases evaporative cooling over at least one desired location on the body of the user of the invention.
